(19) United States
(12) Patent Application Publication
(10) Pub. No.: US 2010/0301735 A1
(43) Pub. Date: Dec. 2, 2010

(54) LIGHT EMISSION DEVICE AND DISPLAY DEVICE USING THE SAME

(76) Inventor: Bok-Chun Yun, Suwon-si (KR)

Correspondence Address: CHRISTIE, PARKER & HALE, LLP, PO BOX 7068, PASADENA, CA, 91109-7068, US

(21) Appl. No.: 12/786,258

(22) Filed: May 24, 2010

(30) Foreign Application Priority Data
May 26, 2009 (KR) 10-2009-0046034

(51) Int. Cl. H01J 1/02

(52) U.S. Cl. 313/310

(57) ABSTRACT

A light emission device includes a substrate body having a concave portion extending along a first direction within the substrate body; a first electrode within the concave portion and extending along the first direction, the first electrode having a portion separated into a plurality of separate parts, the plurality of separate parts being parallel to each other; a second electrode on a front surface of the substrate body and extending along a second direction crossing the first electrode; and an electron emission unit on the first electrode and spaced apart from the second electrode.

### CROSS-REFERENCE TO RELATED APPLICATION

This application claims priority to and the benefit of Korean Patent Application No. 10-2009-0046034, filed in the Korean Intellectual Property Office on May 26, 2009, the entire content of which is incorporated herein by reference.

### BACKGROUND

1. Field

The following description relates to a light emission device and a display device using the same, and more particularly, to a light emission device using a field emission effect and a display device using the same.

2. Description of Related Art

A light emission device can emit light and include a light emission device using a field emission effect. A light emission device using the field emission effect can include a light emission device that includes a front substrate formed with a phosphor layer (or a fluorescent layer) and an anode electrode (anode), and a rear substrate formed with electron emission regions and driving electrodes. Here, edges (edge portions) of the front substrate and the rear substrate are joined to each other by a sealing member, and an inner space between the front and rear substrates is evacuated to form a vacuum container (vacuum chamber) with the sealing member.

The driving electrodes include cathode electrodes (cathodes) and gate electrodes spaced apart from the cathode electrodes. Here, the gate electrodes extend in a direction crossing the cathode electrodes. In addition, openings are formed on the gate electrodes to correspond to crossing regions of the cathode electrodes and the gate electrodes, and the electron emission units (emission regions) are disposed on the cathode electrodes to be spaced apart from the gate electrodes.

By this configuration, when a set or predetermined driving voltage is applied to a cathode electrode and a corresponding gate electrode, an electric field is formed around a corresponding electron emission unit (emission region) due to a difference in voltage between the cathode and gate electrodes so that electrons are emitted from the electron emission unit. The emitted electrons collide with the phosphor layer by being induced by high voltage applied to the anode electrode and excite the phosphor layer, such that the phosphor layer emits visible light.

Also, in order to separate the electron emission unit from the gate electrode and effectively reduce or minimize a diffusion angle of an electron beam emitted from the electron emission region, a structure in which a concave portion (groove) is formed into the rear substrate, and the cathode electrode and the electron emission unit are disposed in the groove of the rear substrate is used. In addition, in order to improve the efficiency of a manufacturing process, the bottom of the groove formed on the rear substrate and the cathode electrode disposed in the groove are flattened to have a stripe pattern.

However, when the cathode electrode is flattened, the electric field generated between the gate electrode and the cathode electrode is not efficient.

The above information disclosed in this Background section is only for enhancement of understanding of the background of the described technology and therefore it may contain information that does not form the prior art that is already known in this country to a person of ordinary skill in the art.

### SUMMARY OF THE INVENTION

Aspects of embodiments of the present invention are directed toward a light emission device having improved electron emission characteristics (e.g., increased emission of electrons) by efficiently generating an electric field, and a display device using the same.

An exemplary embodiment provides a light emission device that includes: a substrate body having a concave portion extending along a first direction within the substrate body; a first electrode within the concave portion and extending along the first direction, the first electrode having a portion separated into a plurality of separate parts, the plurality of separate parts being parallel to each other; a second electrode on a front surface of the substrate body and extending along a second direction crossing the first electrode; and an electron emission unit on the first electrode and spaced apart from the second electrode.

The first electrode may include a single line part and a branch line part, the branch line part may include the plurality of separate parts extending from the single line part.

The branch line part of the first electrode may be positioned at a crossing region of the first electrode and the second electrode, and the electron emission unit may be formed on the branch line part of the first electrode.

The single line part of the first electrode may connect the branch line part and an adjacent branch line part to each other.

The single line part of the first electrode may be positioned at either end of the first electrode.

The second electrode may include a mesh unit spaced apart from the electron emission unit at the crossing region of the first electrode and the second electrode and a support unit joined to the substrate body while surrounding the mesh unit.

The mesh unit may include a plurality of opening portions for passing through electrons emitted from the electron emission unit.

The second electrode may be formed by a metal plate having a larger thickness than that of the first electrode.

The concave portion may have a larger width than that of the first electrode, and the concave portion may be formed with a larger recession depth than a sum of a thickness of the first electrode and a thickness of the electron emission unit.

A portion of the substrate body between the concave portion and an adjacent concave portion of the substrate body may serve as a partition separating the first electrode and an adjacent first electrode within the adjacent concave portion from each other.

The light emission device may further include an additional substrate body facing the substrate body, and a third electrode and a phosphor layer formed on a surface of the additional substrate body facing the substrate body.

Another embodiment provides a display device that includes the light emission device and a display panel displaying an image by receiving light from the light emission device.

According to an embodiment, a light emission device can increase or maximize emission of electrons by efficiently generating an electric field.

Further, a display device can include the light emission device.

### BRIEF DESCRIPTION OF THE DRAWINGS

FIG. 1 is a partial perspective view of a light emission device according to a first embodiment;

FIG. 2 is a partial cross-sectional view of a light emission device of FIG. 1;

FIG. 3 is a plan view of a first electrode of FIG. 1;

FIG. 4 is a plan view of a first electrode of a light emission device according to a second embodiment;

FIG. 5 is an exploded perspective view of a display device including the light emission device of FIG. 1; and

FIG. 6 is a partial cross-sectional view of a display panel of FIG. 5.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” an other element, it can be directly on the other element or be indirectly on the other element with one or more intervening elements interposed therebetween. In contrast, when an element is referred to as being “directly on” an other element, there are no intervening elements present. Like reference numerals designate like elements throughout the specification.

Further, since sizes and thicknesses of constituent members shown in the accompanying drawings are provided for better understanding and ease of description, the present invention is not limited to the illustrated sizes and thicknesses.

In the drawings, the thickness of layers, films, panels, regions, etc., are exaggerated for clarity.

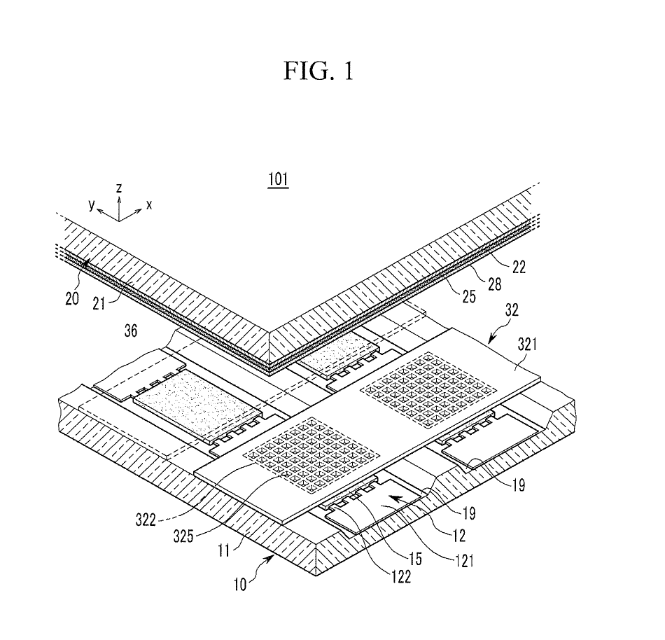

Hereinafter, referring to FIGS. 1 to 3, a light emission device 101 according to a first embodiment will be described.

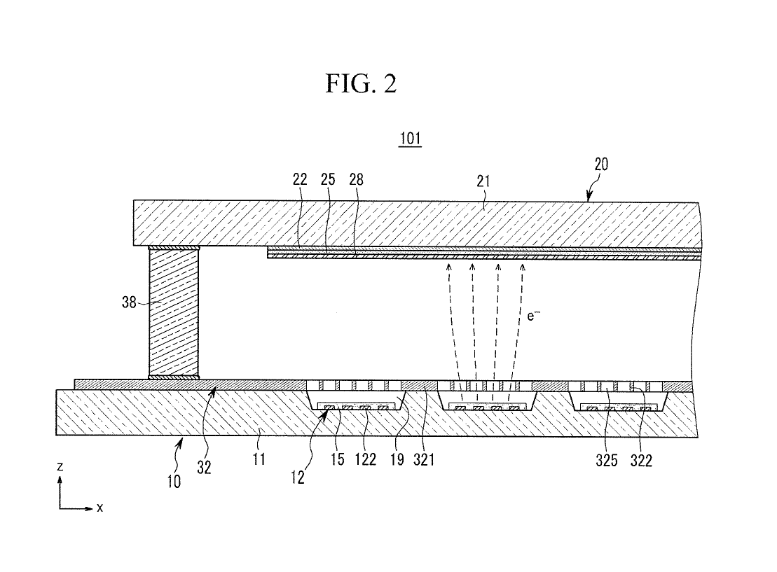

As shown in FIG. 1, the light emission device 101 includes a first substrate assembly 10, a second substrate assembly 20 facing the first substrate assembly 10, and a sealing member 38 (shown in FIG. 2) that is disposed at edges (edge portions) of the first substrate assembly 10 and the second substrate assembly 20 to bond and seal the two substrate assemblies 10 and 20 to each other. The inner space formed by the first substrate assembly 10, the second substrate assembly 20, and the sealing member 38 is evacuated to be in a vacuum state maintained at a vacuum degree of about 10⁻⁶ Torr.

The first substrate assembly 10 includes a substrate or substrate body (hereinafter, referred to as “first substrate body 11”), a first electrode 12, an electron emission unit (emission region) 15, and a second electrode 32. Here, the first electrode 12 is a cathode electrode (cathode) and the second electrode 32 is a gate electrode. However, the first embodiment is not limited thereto, and the first electrode 12 may be the gate electrode and the second electrode 32 may be the cathode electrode in some cases.

The first substrate body 11 has a concave (recess) portion (groove) 19 recessed into the first substrate body 11 and formed to have a stripe pattern to extend along a first direction. The concave portion (groove) 19 is formed by removing a part of the first substrate body 11 by a method such as etching and/or sand blasting. In FIGS. 1 and 2, the concave portion 19 of the first substrate body 11 has an inclined side wall, but the present invention is not limited thereto. For example, the concave portion 19 of the first substrate body 11 may have a vertical side wall.

In one embodiment, the first substrate body 11 has a thickness of about 1.8 mm. Further, the concave portion 19 may have a depth of about 40 μm and a width of 300 to 600 μm.

The first electrode 12 is disposed on the bottom of the concave portion 19 of the first substrate body 11. Here, the first electrode 12 is formed in a stripe pattern to extend along the first direction (y-axis direction) parallel to the extension direction of the concave portion 19. That is, the length direction (y-axis direction) of the first electrode 12 is the same as the length direction (y-axis direction) of the concave portion 19. In addition, portions of the first substrate body 11 separating the concave portions 19 serve as partitions for separating the adjacent first electrodes 12 from each other.

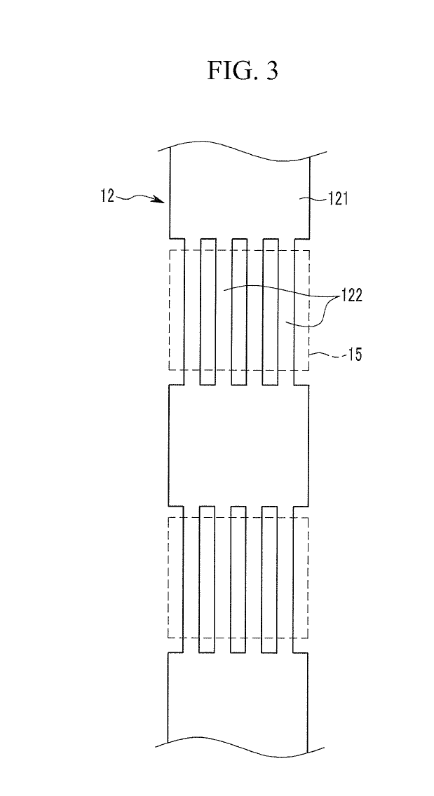

Further, at least a portion of the first electrode 12 is divided into a plurality of parts that are parallel to each other. That is, as shown in FIG. 3, the first electrode 12 includes a single line part 121 and a branch line part 122 having a plurality of divided (separate) parts parallel to each other and extending from the single line part 121. In FIGS. 1 and 3, the branch line part 122 of the first electrode 12 is divided into four separate parts, but the first embodiment is not limited thereto. Therefore, the branch line part 122 of the first electrode 12 can be suitably formed to have two or more separate parts.

As shown in FIG. 2, the second electrode 32 is formed to have a stripe pattern to extend in a second direction (x-axis direction) crossing the first electrodes 12 and formed above the front surface of the first substrate body 11. Therefore, the second electrode 32 is separated from the first electrode 12 disposed in the concave portion 19 of the first substrate body 11 by approximately the depth of the concave portion 19.

The electron emission unit 15 is formed just above the first electrode 12 to be spaced apart from the second electrode 32. The electron emission unit 15 contains materials that emit electrons by being applied with an electric field in a vacuum state, i.e., a carbon-based material and/or a nanometer-sized material. The electron emission unit 15 may contain, for example, carbon nanotubes, graphite, graphite nanofibers, diamond, diamond-like carbon, fullerene (C₆₀), silicon nanowire, and combinations thereof.

The electron emission unit 15 may be constituted by an electron emission layer having a set or predetermined thickness through thick-film processing such as screen printing. That is, the electron emission unit 15 may be formed by processes of screen-printing a paste-shaped mixture containing an electron emission material on the first electrode 12, drying and sintering the printed mixture, and activating the surface of the electron emission unit 15 so as to expose the electron emission materials to the surface of the electron emission unit 15. The surface activation process can be made by attaching an adhesive tape and then detaching the same. The electron emission materials such as carbon nanotubes can be substantially vertically erected with respect to the surface of the emission electron unit 15 while removing a part of the surface of the electron emission unit 15 through the surface activation process.

As shown in FIG. 1, in the first embodiment, the branch line part 122 of the first electrode 12 is positioned in a region crossing the second electrode 32, and the electron emission unit 15 is formed just above the branch line part 122 of the first electrode 12. Further, the single line part 121 of the first electrode 12 connects the branch line parts 122 that are adjacent to each other.

According to the structure, an electric field is efficiently formed between the branch line part 122 of the first electrode 12 and the second electrode 32. The reason for this is that since the branch line part 122 of the first electrode 12 is divided into several parts, the edge of the first electrode 12 is increased, thereby more efficiently providing the electric field. Further, since the electron emission unit 15 is formed just above the branch line part 122 of the first electrode 12, it is possible to increase or maximize emission of electrons at the time of driving the electron emission unit 15.

As such, as the number of divided (separate) parts of the branch line part 122 of the first electrode 12 is increased, the electric field can be more efficiently provided. However, as the number of divided parts of the branch line part 122 and the length of the branch line part 122 are increased, line resistance can be increased. Therefore, to suppress the line resistance and according to one embodiment, the sizes of and lengths of the branch line part 122 and the single line part 121 are suitably adjusted and distributed.

Further, the second electrode 32 includes a mesh unit 322 spaced apart from the first electrode 12 on the electron emission unit 15 in the region crossing the first electrode 12, and a support unit 321 joined to (in contact with) the first substrate body 11 while surrounding the mesh unit 322. Herein, the mesh unit 322 has a plurality of opening portions 325 for passing electrons emitted from the electron emission unit 15.

As shown in FIG. 2, in the first embodiment, the mesh unit 322 of the second electrode 32 is formed on the electron emission unit 15 in the region crossing the first electrode 12. Electrons emitted from the electron emission unit 15 move toward the second substrate 20 by passing through the mesh unit 322 of the second electrode 32. Therefore, the mesh unit 322 of the second electrode 32 serves to focus the passing electrons. Further, since the mesh unit 322 of the second electrode 32 is formed in only the region crossing the first electrode 12, it is possible to reduce or prevent a voltage drop of the second electrode 32 during driving by reducing line resistance of the second electrode 32.

Here, in FIGS. 1 and 2, the mesh unit 322 of the second electrode 32 is formed only in the region crossing the first electrode 12, but the present invention is not limited thereto. For example, the mesh unit 322 can be formed even in a region not crossing the first electrode 12 in addition to the region crossing the first electrode 12. That is, the mesh unit 322 of the second electrode 32 may be formed in the region crossing the first electrode 12 and between the regions crossing the first electrode 12. In this case, an area occupied by the support unit 321 of the second electrode 32 is reduced. In addition, a part of the mesh unit 322 of the second electrode 32 is also in direct contact with the front surface of the first substrate body 11. However, in this example, a process of arranging the second electrodes 32 can be more easily performed. Accordingly, since the arrangement is easy at the time of disposing the second electrode 32, productivity can be improved.

Further, the support unit 321 of the second electrode 32 faces the front surface of the first substrate body 11 and is joined to the first substrate body 11 through the sealing member 38 disposed at the edge (edge portion) of the first substrate body 11 and/or an additional adhesive member.

Further, the second electrode 32 is formed by a metal plate having a larger thickness than the first electrode 12. For example, the second electrode 32 can be manufactured through a step of forming the opening portion 325 by cutting the metal plate to have a stripe pattern and removing a part of the metal plate by using a method such as etching. The second electrode 32 can be made of a nickel-iron alloy and/or a metallic material other than the alloy, and can be formed with a thickness of about 50 μm and a width of about 10 mm. After the second electrode 32 is manufactured by a process other than that of the first electrode 12 and the electron emission unit 15, the second electrode 32 is fixed on the front surface of the first substrate body 11 to extend in the direction crossing the first electrode 12. Here, since the first electrode 12 and the electron emission unit 15 are positioned in the concave portion 19 of the first substrate body 11, it is possible to naturally (automatically) achieve insulation between the first electrode 12 and the second electrode 32 by only fixing the second electrode 32 onto the front surface of the first substrate body 11.

Further, the concave portion 19 of the first substrate body 11 has a larger width than the first electrode 12, and has a larger recession depth than the sum of the thicknesses of the first electrode 12 and the electron emission unit 15. Therefore, the second electrode 32 is stably separated from the first electrode 12 disposed in the concave portion 19 of the first substrate body 11. That is, the first electrode 12 and the second electrode 32 are stably insulated from each other.

Further, one crossing region of the first electrode 12 and the second electrode 32 may be positioned at one pixel area of the light emission device 101, or two or more crossing regions may be positioned at one pixel area of the light emission device 101. In the latter case, the first electrodes 12 or the second electrodes 32 corresponding to one pixel area are electrically connected to each other to be applied with the same voltage.

The second substrate assembly 20 includes a substrate or substrate body (hereinafter, referred to as “second substrate body 21”), a third electrode 22, a phosphor layer (or a fluorescent layer) 25, and a reflection film 28. The third electrode 22, the phosphor layer 25, and the reflection film 28 are sequentially formed on an inner surface of the second substrate body 21 facing the first substrate assembly 10. That is, the third electrode 22, the phosphor layer 25, and the reflection film 28 are sequentially arranged adjacent to the second substrate body 21. Here, the third electrode 22 is the anode electrode. In addition, the first substrate body 11 and the second substrate body 21 may be made of a ceramic-based material such as glass, for example.

The third electrode 22 is made of a transparent conductive material such as indium tin oxide (ITO) so as to transmit visible light emitted from the phosphor layer 25. The third electrode 22 is an acceleration electrode for inducing the electrons to collide with the phosphor layer 25 by maintaining the phosphor layer 25 in a high-voltage state by being applied with a positive direct-current voltage (hereinafter, referred to as “anode voltage”) of thousands of volts.

The phosphor layer 25 can be formed of a mixed phosphor and/or fluorescent material that emits white light by mixing a red phosphor and/or fluorescent material, a green phosphor and/or fluorescent material, and a blue phosphor and/or fluorescent material with each other. In FIGS. 1 and 2, the phosphor layer 25 is formed in the entire light emission area of the second substrate body 21, but the present invention is not limited thereto. For example, the phosphor layer 25 may be separately formed in each pixel area.

The reflection film 28 may be constituted by an aluminum thin film having a thickness of thousands of angstroms (Å), and has minute holes for passing the electrons. The reflection film 28 reflects the visible light emitted toward the first substrate 10 among visible light emitted from the phosphor layer 25 to increase the luminance of the light emission device 101.

In addition, the third electrode 22 or the reflection film 28 may be omitted. In the case where the third electrode 22 is omitted, the reflection film 28 can perform the same function as the third electrode 22 by being applied with the anode voltage.

By this configuration, in pixels where a voltage difference between the first electrode 12 and the second electrode 32 is equal to or larger than a threshold value, an electric field is formed around the electron emission unit 15, thereby emitting electrons. In particular, since the electric field is more efficiently formed between the branch line part 122 of the first electrode 12 and the second electrode 32, it is possible to increase or maximize the emission amount of electrons emitted by the electron emission unit 15 that is formed just above the branch line part 122 of the first electrode 12. The emitted electrons collide with a corresponding portion of the phosphor layer 25 by being induced by the anode voltage applied to the third electrode 22 so as to allow the corresponding phosphor layer to emit the light. The luminance of the phosphor layer 25 for each pixel corresponds to the emission quantity of electron beams of the corresponding pixel.

Further, since the mesh unit 322 of the second electrode 32 is disposed on the electron emission unit 15, electrons emitted from the electron emission unit 15 pass through the opening portion 325 of the mesh unit 322 in the state of reduced or minimized beam dispersion and reach the phosphor layer 25. Accordingly, the light emission device 101 can effectively prevent or protect a side wall of the concave portion 19 from being charged with electric charges by reducing an initial dispersion angle of the electrons.

As a result, the light emission device 101 according to the first embodiment can stabilize driving by improving withstand voltage characteristics of the first electrode 12 and the second electrode 32 and implement high luminance by applying a high voltage of 10 kV or more, and, in one embodiment, a high voltage of 10 to 15 kV, to the third electrode 22.

Further, in the case of the light emission device 101 according to the first embodiment, since the thick-film processing for forming the insulating layer and the thin-film processing for forming the second electrode 32 can be omitted, it is possible to simplify the manufacturing process.

Further, since the second electrode 32 is disposed after forming the electron emission unit 15, it is possible to prevent or block the first electrode 12 and the second electrode 32 from being short-circuited due to a conductive electron emission material between the first electron 12 and the second electrode 32 while forming the electron emission unit 15 in the related art.

By the above-mentioned configuration, the light emission device 101 can increase or maximize emission of electrons by efficiently generating the electric field.

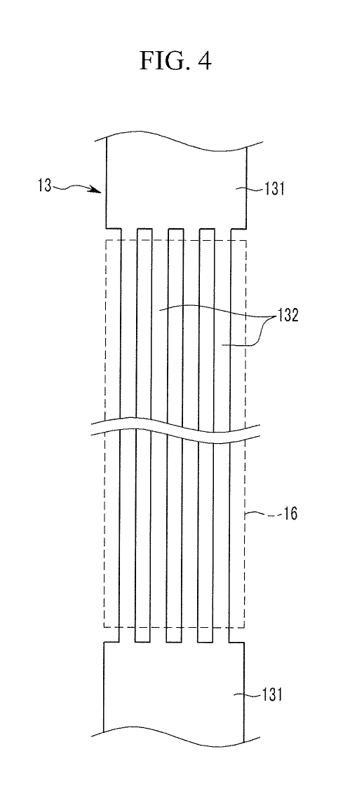

Hereinafter, referring to FIG. 4, a light emission device according to a second embodiment will be described.

As shown in FIG. 4, in the second embodiment, a first electrode 13 of the light emission device includes (or only includes) single line parts 131 positioned at both ends of the first electrode 13, respectively, and a branch line part 132 connecting both single line parts 131. Further, in one embodiment, an electron emission unit 16 formed just above the branch line part 132 of the first electrode 13 is formed to have a stripe pattern to extend along the branch line part 132 of the first electrode 13 such that the electron emission unit 16 extends through a region crossing the second electrode 32 (shown in FIG. 1) and regions not crossing the second electrode 32.

By this configuration, the light emission device 101 can further facilitate a process of arranging the first electrode 13 and the second electrode 32 with each other (without an extra alignment) while increasing or maximizing emission of electrons by efficiently generating an electric field. Accordingly, the productivity of the light emission device can be further improved.

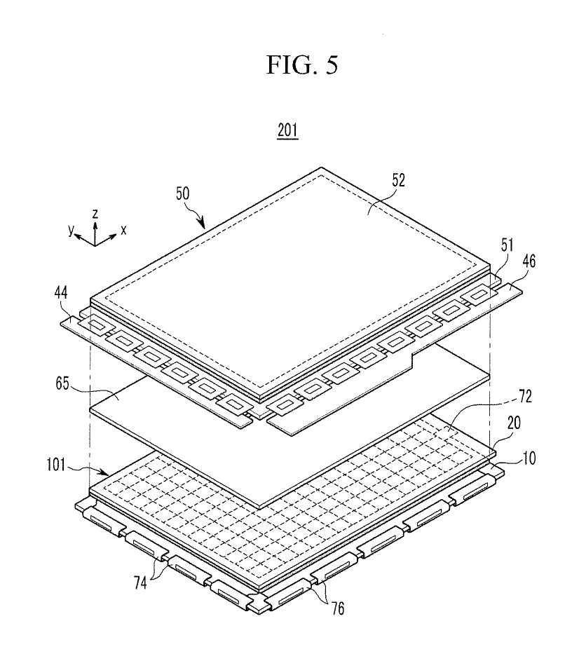

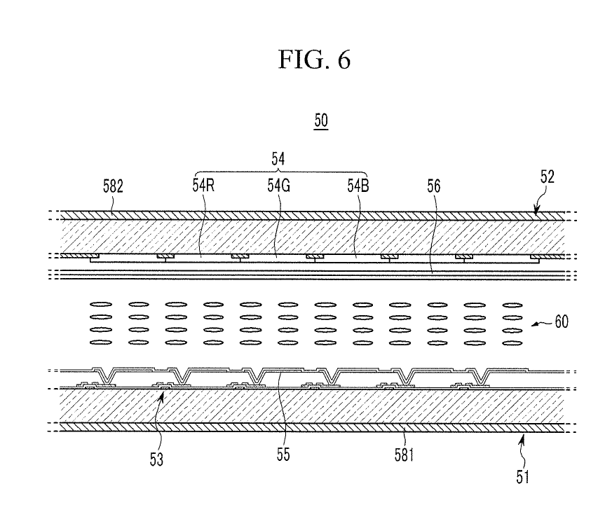

Hereinafter, referring to FIGS. 5 and 6, a display device 201 according to an embodiment will be described. The display device 201 according to the embodiment may include the light emission devices according to the above-mentioned first and second embodiments. Hereinafter, the display device 201 with the light emission device 101 of FIG. 1 will be described as an example.

As shown in FIG. 5, the display device 201 includes the light emission device 101 and a display panel 50 disposed in the front of the light emission device 101. Further, the display device 201 may (or may not) include a diffusion member 65 that is disposed between the light emission device 101 and the display panel 50 to evenly diffuse light emitted from the light emission device 101. The diffusion member 65 and the light emission device 101 are spaced from each other by a set or predetermined distance. The display device 201 includes the light emission device 101 according to the first embodiment as a light source.

In FIGS. 5 and 6, a liquid crystal display panel is used as the display panel 50, but the present invention is not limited thereto. Therefore, the display panel 50 may be a non-emissive display panel other than the liquid crystal display panel.

As shown in FIG. 6, the display panel 50 includes a first display plate 51 where a thin film transistor (TFT) 53 and a pixel electrode 55 are formed, a second display plate 52 where a color filter layer 54 and a common electrode 56 are formed, and a liquid crystal layer 60 injected between the first display plate 51 and the second display plate 52. Polarizing plates 581 and 582 are attached to a front surface of the first display plate 51 and a rear surface of the second display plate 52 to polarize light passing through the display panel 50.

The pixel electrode 55 is positioned in each sub-pixel. Driving of the pixel electrode 55 is controlled by the thin film transistor 53. Here, a plurality of sub-pixels (e.g., three sub-pixels) implementing different colors are grouped together to constitute one pixel. The pixel is a minimum unit for displaying an image. The pixel electrode 55 and the common electrode 56 are made of a transparent conductive material. The color filter layer 54 includes a red filter layer 54R, a green filter layer 54G, and a blue filter layer 54B that are positioned in the sub-pixels, respectively.

When the thin film transistor 53 of a sub-pixel is turned on, an electric field is formed between the pixel electrode 55 and the common electrode 56. Array angles of liquid crystal molecules of the liquid crystal layer 60 are changed by the electric field. Light permeability is changed according to the changed array angles of the liquid crystal molecules. The display panel 50 can display the image by controlling luminance and illumination color for each pixel through this process.

Further, the display panel 50 is not limited to the above-mentioned structure, and may be modified to have various suitable configurations.

In addition, as shown in FIG. 6, the display device 201 includes a gate circuit substrate 44 supplying a gate driving signal to a gate electrode of each thin film transistor 53 of the display panel 50, and a data circuit substrate 46 supplying a data driving signal to a source electrode of each thin film transistor 53 of the display panel 50.

The light emission device 101 allows one pixel of the light emission device 101 to correspond to two or more pixels of the display panel 50 and is formed to have fewer pixels than that of the display panel 50.

Each pixel of the light emission device 101 can emit light in accordance with the gray levels of the pixels of the display panel 50 corresponding thereto. For example, each pixel can emit light in accordance with the highest gray level among the gray levels of the pixels of the display panel 50. Each pixel of the light emission device 101 can display gray levels in a gray-scale of 2 to 8 bits.

Hereinafter, for convenience of description, a pixel of the display panel 50 is referred to as a first pixel, a pixel of the light emission device 101 is referred to as a second pixel, and first pixels corresponding to one second pixel are referred to as a first pixel group.

A driving process of the light emission device 101 may include a step of allowing a signal controller controlling the display panel 50 to detect the highest gray level of the gray levels of the first pixels of the first pixel group, a step of calculating a gray level required for emitting the second pixel in accordance with the detected gray level and converting the calculated gray level into digital data, a step of generating a driving signal of the light emission device 101 by using the digital data, and a step of applying the generated driving signal to a driving electrode of the light emission device 101.

The driving signal of the light emission device 101 includes a scanning signal and a data signal. Either of the first electrode 12 or the second electrode 32 is applied with the scanning signal, and the other is applied with the data signal.

Further, although not shown, a data circuit substrate and a scanning circuit substrate for driving the light emission device 101 may be disposed on a rear surface of the light emission device 101. The data circuit substrate and the scanning circuit substrate are connected to the first electrode 12 and the second electrode 32 through a first connector 76 and a second connector 74, respectively. In addition, a third connector 72 applies the anode voltage to the third electrode 22.

As described above, the second pixel of the light emission device 101 is synchronized with the first pixel group to emit light at a set or predetermined gray level when the image is displayed in the corresponding first pixel group. That is, the light emission device 101 provides light having high luminance to a bright region in a screen implemented by the display panel 50 and provides light having low luminance to a dark region of the screen. Therefore, the display device 201 according to the embodiment can increase a contrast ratio of the screen and implement clearer image quality.

By the above-mentioned configuration, the display device 201 can include the light emission device 101 that can increase or maximize emission of electrons by efficiently generating the electric field.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A light emission device, comprising:
a substrate body having a concave portion extending along a first direction within the substrate body;
a first electrode within the concave portion and extending along the first direction, the first electrode having a portion separated into a plurality of separate parts, the plurality of separate parts being parallel to each other;
a second electrode on a front surface of the substrate body and extending along a second direction crossing the first electrode; and
an electron emission unit on the first electrode and spaced apart from the second electrode.

2. The light emission device of claim 1, wherein
the first electrode comprises a single line part and a branch line part, the branch line part comprising the plurality of separate parts extending from the single line part.

3. The light emission device of claim 2, wherein
the branch line part of the first electrode is at a crossing region of the first electrode and the second electrode, and
the electron emission unit is on the branch line part of the first electrode.

4. The light emission device of claim 3, wherein
the single line part of the first electrode connects the branch line part and an adjacent branch line part of the first electrode to each other.

5. The light emission device of claim 3, wherein
the single line part of the first electrode is positioned at either end of the first electrode.

6. The light emission device of claim 3, wherein
the second electrode comprises a mesh unit spaced apart from the electron emission unit at the crossing region of the first electrode and the second electrode and a support unit joined to the substrate body while surrounding the mesh unit.

7. The light emission device of claim 6, wherein
the mesh unit comprises a plurality of opening portions for passing through electrons emitted from the electron emission unit.

8. The light emission device of claim 6, wherein
the second electrode is composed of a metal plate having a larger thickness than that of the first electrode.

9. The light emission device of claim 3, wherein
the concave portion has a larger width than that of the first electrode, and
the concave portion has a larger recession depth than a sum of a thickness of the first electrode and a thickness of the electron emission unit.

10. The light emission device of claim 9, wherein
a portion of the substrate body between the concave portion and an adjacent concave portion of the substrate body serves as a partition separating the first electrode and an adjacent first electrode within the adjacent concave portion from each other.

11. The light emission device of claim 3, further comprising:
an additional substrate body facing the substrate body; and
a third electrode and a phosphor layer on a surface of the additional substrate body facing the substrate body.

12. A display device, comprising:
a light emission device comprising:
a substrate body having a concave portion extending along a first direction within the substrate body;
a first electrode within the concave portion and extending along the first direction, the first electrode having a portion separated into a plurality of separate parts, the plurality of separate parts being parallel to each other;
a second electrode on a front surface of the substrate body and extending along a second direction crossing the first electrode; and
an electron emission unit on the first electrode and spaced apart from the second electrode; and
a display panel configured to display an image by receiving light from the light emission device.
